(19) United States
(12) Patent Application Publication
(10) Pub. No.: US 2024/0247209 A1
(43) Pub. Date: Jul. 25, 2024

(54) POLYESTER POLYQUATS IN CLEANING APPLICATIONS

(71) Applicant: NOURYON CHEMICALS INTERNATIONAL B.V., Amsterdam (NL)

(72) Inventors: Josmary Alejandra VELÁSQUEZ CANO, Västerlanda (SE); Natalija SMOLKO SCHWARZMAYR, Haelteby (SE); Mikael Ivar WIDELL, Hålta (SE)

(73) Assignee: NOURYON CHEMICALS INTERNATIONAL B.V., Amsterdam (NL)

(21) Appl. No.: 18/561,856

(22) PCT Filed: May 18, 2022
(86) PCT No.: PCT/EP2022/063428

§ 371 Date: Nov. 17, 2023

Related U.S. Application Data
(60) Provisional application No. 63/189,818, filed on May 18, 2021.

(51) Int. Cl. C11D 3/37; C08G 63/685; C08G 63/91; C11D 1/72

(52) U.S. Cl. CPC C11D 3/3715; C08G 63/6856; C08G 63/916; C11D 1/72

(57) ABSTRACT

The present disclosure relates to a method of cleaning a surface to be cleaned, wherein said surface is selected from a household item or a vehicle, said method comprising contacting said surface with an aqueous solution comprising a polyester polyquaternary (PEPQ) compound. Formulations useful for this purpose are also disclosed.

### PRIORITY CLAIM

This application is a U.S. National-Stage entry under 35 U.S.C. § 371 based on International Application No. PCT/EP2022/063428, filed May 18, 2022, which was published under PCT Article 21(2) and which claims priority of U.S. Provisional Application Ser. No. 63/189,818, filed May 18, 2021, the entire contents of which are hereby incorporated herein by reference.

### FIELD OF THE DISCLOSURE

The present disclosure relates to the use of polyester polyquats (PEPQs) in cleaning applications.

### BACKGROUND OF THE DISCLOSURE

Polyester polyquaternary ammonium compounds are known and used in a variety of applications due to their good performance and excellent environmental characteristics.

EP 0 980 352 B1 relates to compounds obtained by the reaction of triethanolamine with fatty acids and dicarboxylic acids, and/or the corresponding quaternized compounds thereof, and also to textile-softening compositions containing these compounds.

In WO 2012/028542, WO 2012/089649 and WO 2011/000895, a number of different polyester polyquaternary ammonium compounds have been described for use within the field of corrosion inhibitors.

EP 1 136 471 A1 relates to products based on the esterification of alkanolamines, optionally alkoxylated, dicarboxylic acids and fatty alcohols, optionally alkoxylated, and esterquats obtainable therefrom. The products are usable in treatments for softening and conditioning of textiles, paper and hair.

EP 0 770 595 A1 relates to esterquats obtained by reacting trialkanolamine with a mixture of fatty acids, dicarboxylic acids and sorbitol, optionally ethoxylating the ester, and quaternizing the product. These esterquats are used in the preparation of surface active agents, especially for hair and personal care.

WO 2011/147855 describes the process of floating calcium carbonate containing silicates as impurity, using as collectors ester quaternary compounds, which are obtainable by the condensation of a fatty alcohol, optionally alkoxylated, a fatty acid alkanolamide, optionally alkoxylated, or an alkoxylated secondary amine, a dicarboxylic acid or a derivative thereof and an alkanolamine, where the condensation product has been quaternized by a suitable alkylating agent.

EP 1 949 963 B1 relates to the flotation of non-sulfidic minerals and ores where polymeric esterquats, obtained by reacting alkanolamines, fatty acids and dicarboxylic acids and quaternizing the resulting esters, are used as collectors.

U.S. Pat. No. 10,100,146 describes polyester polyquats obtainable by the condensation of a polyol having 3-4 hydroxyl groups, a dicarboxylic acid or a derivative thereof, an alkanolamine and a fatty acid, followed by reaction with an alkylating agent. This compound is described as being useful as a collector in a process for the reverse froth flotation of non-sulfidic ores containing silicate as impurities, especially phosphate ores.

WO 2013/092440 mentions the use of PEPQs as cleaning and descaling agents for metal surfaces of equipment used in the oil and gas industry. However, the attributes of these compounds in the context of cleaning is not detailed. Instead, the PEPQs are described as having the ability to inhibit corrosion and to remove small particles and inorganic scale.

It is an object of the present disclosure to adapt these types of compounds to other uses. In addition, other objects, desirable features and characteristics will become apparent from the subsequent summary and detailed description, and the appended claims, taken in conjunction with the accompanying drawings and this background.

### BRIEF SUMMARY

This disclosure provides a method of cleaning a surface of a household item or a vehicle, said method comprising contacting the surface with an aqueous solution comprising a polyester polyquaternary (PEPQ) compound.

### BRIEF DESCRIPTION OF THE DRAWINGS

The present disclosure will hereinafter be described in conjunction with the following drawing figures, wherein like numerals denote like elements, and:

FIG. 1 is a graph showing the influence of various hydrotropic additives on the cloud points of a hydrophobic formulation comprising 5% ethoxylated alcohol (C9-11 4EO) and 3.8% GLDA.

### DETAILED DESCRIPTION OF THE PREFERRED EMBODIMENTS

The following detailed description is merely exemplary in nature and is not intended to limit the present disclosure or the application and uses of the present disclosure. Furthermore, there is no intention to be bound by any theory presented in the preceding background of the present disclosure or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

The present disclosure relates in one embodiment to a method of cleaning a surface to be cleaned, wherein said surface is selected from a household item or a vehicle, said method comprising contacting said surface with an aqueous solution comprising a polyester polyquaternary (PEPQ) compound.

The term “household item” as used herein refers to items normally found in the home that would be accessible to the homeowner and normally would be cleaned by the homeowner, such as, for example, tabletops, kitchen and bathroom counters, appliances, furniture, kitchen utensils, windows, floors, kitchen and bathroom fixtures, and the like. The term “household item” is not intended to cover equipment used in or unique to the oil and gas industry.

The present disclosure relates in a second embodiment to cleaning formulations useful to carry out the foregoing method.

In a first preferred embodiment, the PEPQ is one prepared by the reaction of an alkoxylated fatty amine, or a quaternized derivative of said amine, with a multicarboxylic acid or a derivative thereof.

In one embodiment, the PEPQ of this type is one of the compounds described in WO 2011/000895, the entire contents of which are hereby incorporated herein by reference.

In another embodiment, the PEPQ of this type is obtainable by the reaction of an alkoxylated fatty amine having the formula:

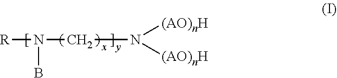

wherein R is a hydrocarbyl group having 8-24 carbon atoms, preferably 12 to 24 carbon atoms; each B is, independently, an alkyl group having 1-4 carbon atoms, a benzyl group, or the group (AO)ₙH, wherein AO is an alkyleneoxy group containing 2-4 carbon atoms, preferably 2 carbon atoms; each n is, independently, at least 1 and the sum of all n is 2-30, preferably 2-15, more preferably 2-10, and most preferably 2-5; x is 2 or 3; and y is 0-3, preferably 0 or 1; or of a product obtainable by partial or total quaternization of the alkoxylated fatty amine of formula (I); with a non-hydrophobic multicarboxylic acid derivative having the formula:

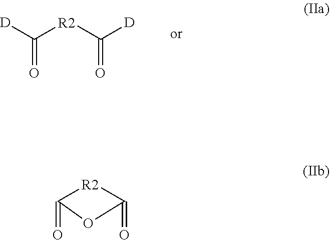

wherein D is —OH, —Cl, or —OR3, wherein R3 is a C₁-C₄ alkyl group; R2 is an alkylene radical of formula —(CH₂)₂—, wherein z is an integer from 0 to 10, preferably from 0 to 6, more preferably from 2 to 4, and most preferably 2, and wherein the alkylene radical may be substituted by 1 or 2 —OH groups, —COOH groups, —COOR3 groups, alkenylene (e.g., —CH═CH—), cycloalkylene, cycloalkenylene, or arylene (e.g., o- or p-phenylene); optionally the reaction between the amine compound and the multicarboxylic acid derivative is followed by partial or total quaternization; and wherein the reaction product, which is optionally quaternized, consists of or includes more than 60% by weight (% w/w) of oligomers/polymers with two or more alkoxylated amine units (optionally quaternized) and one or more multiacid/acid anhydride units and more than 50% w/w of oligomers/polymers with two or more alkoxylated amine units (optionally quaternized) and two or more multiacid/acid anhydride units.

In one embodiment compound (I) is an alkoxylated fatty monoamine having the formula:

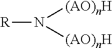

wherein R, AO, and n have the same meaning as above.

In another embodiment (I) is an alkoxylated diamine having the formula:

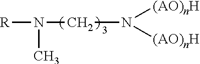

wherein R, AO, and n have the same meaning as above in general formula (I).

In still another embodiment (I) is another alkoxylated diamine having the formula:

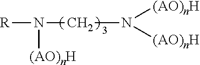

wherein R, AO, and n have the same meaning as above in general formula (I).

Compounds of formula I, wherein all, or essentially all, of the AO groups each represent an ethyleneoxy group, (CH₂CH₂O), are especially preferred.

In further embodiments the amine compounds of formula (I) may be quaternized in a conventional way by reaction with an alkylating agent, e.g. methyl chloride or dimethyl sulphate, before reaction with a multicarboxylic acid derivative (IIa) or (IIb). Either a part of, or all of, the nitrogen atoms may be quaternized. A further embodiment, if a quaternized derivative is desired, relates to a reaction product between the tertiary compound (I) and a multicarboxylic acid derivative (IIa) or (IIb), which is subsequently reacted with an alkylating agent, e.g. methyl chloride or dimethyl sulphate, to yield a product that is partly or totally quaternized. If desired, it is also possible to use both quaternization steps, such that a partially quaternized amine of formula I is reacted with a diacid after which the resulting product is further quaternized, optionally until it is fully quaternized.

Illustrative examples of suitable fatty amines for use as starting materials for the alkoxylated fatty amines include, but are not limited to, (fatty alkyl)monoamines according to formula R1NH₂, wherein R1 is an aliphatic group having 8-24, preferably 12-24 carbon atoms; (fatty alkyl)diamines according to formula R2NHCH₂CH₂CH₂NH₂, wherein R2 is an aliphatic group having 8-24, preferably 12-24 carbon atoms; linear (fatty alkyl)triamines according to formula R3NHCH₂CH₂CH₂NHCH₂CH₂CH₂NH₂, wherein R3 is an aliphatic group having 8-24, preferably 12-24 carbon atoms; and linear (fatty alkyl)tetramines according to formula R4NHCH₂CH₂CH₂NHCH₂CH₂CH₂NHCH₂CH₂CH₂NH₂, wherein R4 is an aliphatic group having 8-24, preferably 12-24 carbon atoms. More specific examples of the above-mentioned amines include, but are not limited to, 2-ethylhexyl amine, 2-propylheptyl amine, n-octyl amine, n-decyl amine, n-dodecyl amine, (coco alkyl)amine, n-tetradecyl amine, n-hexadecyl amine, n-octadecyl amine, oleyl amine, (tallow alkyl)amine, (hydrogenated tallow alkyl)amine, (rape seed alkyl)amine, (soya alkyl)amine, erucyl amine, N-(n-decyl)-trimethylene diamine, N-(n-dodecyl)-trimethylene diamine, N-(coco alkyl)-trimethylene diamine, N-(rape seed alkyl)-trimethylene diamine, N-(soya alkyl)-trimethylene diamine, N-(tallow alkyl)-trimethylene diamine, N-(hydrogenated tallow alkyl)-trimethylene diamine, N-erucyl trimethylene diamine, N-(n-decyl)-N′-(3-aminopropyl)-1,3-propane diamine, N-(n-dodecyl)-N′-(3-aminopropyl)-1,3-propane diamine, N-(coco alkyl)-N′-(3-aminopropyl)-1,3-propane diamine, N-(rape seed alkyl)-N′-(3-aminopropyl)-1,3-propane diamine, N-(soya alkyl)-N′-(3-aminopropyl)-1,3-propane diamine, N-oleyl-N′-(3-aminopropyl)-1,3-propane diamine, N-(tallow alkyl)-N′-(3-aminopropyl)-1,3-propane diamine, N-(hydrogenated tallow alkyl)-N′-(3-aminopropyl)-1,3-propane diamine, N-erucyl-N′-(3-aminopropyl)-1,3-propane diamine, N-(3-aminopropyl)-N′-[3-(9-decylamino)propyl]-1,3-propane diamine, N-(3-aminopropyl)-N′-[3-(9-dodecylamino)propyl]-1,3-propane diamine, N-(3-aminopropyl)-N′-[3-(9-(coco alkyl)amino)propyl]-1,3-propane diamine, N-(3-aminopropyl)-N′-[3-(9-(rape seed alkyl)amino)propyl]-1,3-propane diamine, N-(3-aminopropyl)-N′-[3-(9-(soya alkyl)amino)propyl]-1,3-propane diamine, N-(3-aminopropyl)-N′-[3-(9-octadecenylamino)propyl]-1,3-propane diamine, N-(3-aminopropyl)-N′-[3-(9-(tallow alkyl)amino)propyl]-1,3-propane diamine, N-(3-aminopropyl)-N′-[3-(9-(hydrogenated tallow alkyl)amino)propyl]-1,3-propane diamine, and N-(3-aminopropyl)-N′-[3-(9-erucylamino)propyl]-1,3-propane diamine.

These fatty amines are then typically alkoxylated with 2-20 EO, 2-20 PO, 2-20 BO, blocks with EO added first and PO and/or BO last; blocks with PO and/or BO added first and EO last; and mixtures of EO and PO and/or BO to produce randomly alkoxylated products of the general formula (I).

Examples of commercial products of formula (I) available from Nouryon Surface Chemistry include Ethomeen C/12, Ethomeen C/15, Ethomeen C/25, Ethomeen T/12, Ethomeen T/15, Ethomeen T/20, Ethomeen T/25, Ethomeen HT/12, Ethomeen O/12, Ethomeen OV/12, Ethomeen S/12, Ethomeen S/17, Ethomeen S/22, Ethoduomeen C/13, Ethoduomeen T/13, Ethoduomeen T13.2G, Ethoduomeen OV13.2, Ethoduomeen T/22, Ethoduomeen T/25, Berol 561, Berol 556, Berol R648 NG, Ethoquad 18/25, Ethoquad C/12, Ethoquad C/25, Ethoquad HT-25, Ethoquad O/12, and Ethoquad O/12PG.

The multicarboxylic acid derivative of general formula IIa or IIb could be a multicarboxylic acid as such, a multicarboxylic acid chloride, a multiester of a multicarboxylic acid, or a cyclic anhydride of a multicarboxylic acid. The alkylene radical —(CH₂)₂— in formula (IIa) and (IIb) may not be substituted by any alkyl or alkenyl groups. The most suitable derivatives are the dicarboxylic acids and tricarboxylic acids and their corresponding cyclic anhydrides. Illustrative examples of dicarboxylic acids and tricarboxylic acids and their derivatives include oxalic acid, masonic acid, succinic acid, citric acid, isocitric acid, propane-1,2,3-tricarboxylic acid, glutaric acid, adipic acid, pimelic acid, phthalic acid, maleic acid, malic acid, tartaric acid, their corresponding acid chlorides, their corresponding methyl or ethyl esters, and their corresponding cyclic anhydrides. All the general reaction types between a compound of formula (I) and an acid derivative of formula (IIa) or (IIb) are well-known in the art, and could be e.g. a direct esterification of the diacid or triacid with the compound of formula (I) or a transesterification of the diester or triester by the compound of formula (I). These reactions will not be discussed in detail here since such information is available in general organic chemistry handbooks.

In one preferred embodiment, the multicarboxylic acid derivative of general formula IIa or IIb is a dicarboxylic acid or a derivative thereof.

In another preferred embodiment, the multicarboxylic acid derivative of general formula IIa or IIb is a tricarboxylic acid or a derivative thereof.

An example of a compound of this type has the formula:

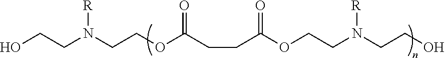

wherein R is a hydrocarbyl group having 8-24 carbon atoms, preferably 12 to 24 carbon atoms, and n is a number of at least 1, preferably at least 2, more preferably at least 3, and most preferably at least 4.

To produce a product according to the example above, where n is 5, a primary fatty alkylamine that has been ethoxylated with two moles of EO is reacted with e.g. succinic anhydride according to the scheme below. However, succinic acid or any of the other dicarboxylic acids, tricarboxylic acids, or derivatives thereof mentioned above may equally well be used.

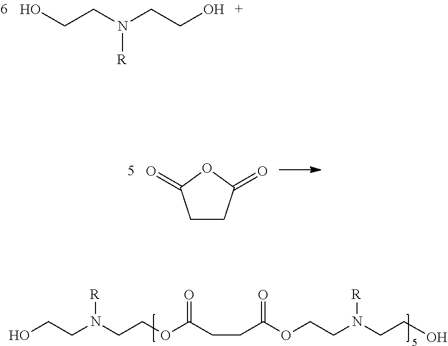

In an embodiment of the disclosure the molar ratio between the reactants (I) and (IIa) or (IIb) is 2:1 to 1:2, preferably 1.5:1 to 1:1.5, and most preferably 1.2:1 to 1:1.

The PEPQ of the formula:

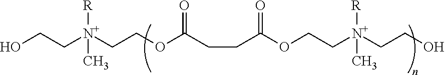

wherein R and n are as indicated immediately above, is prepared by quaternizing the fatty alkylamine prior to reaction with the dicarboxylic acid or derivative. Alternately, it is possible to alkylate the product obtained by reacting the fatty alkylamine with the dicarboxylic acid or derivative.

Quaternization is a reaction type that is well-known in the art. For the quaternization step, the alkylating agent is suitably selected from the group consisting of methyl chloride, methyl bromide, dimethyl sulphate, diethyl sulphate, dimethyl carbonate and benzyl chloride, the most preferred alkylating agents being methyl chloride, dimethyl sulphate, dimethyl carbonate or benzyl chloride.

Quaternization reactions are normally performed in water or a solvent, such as isopropanol (IPA) or ethanol, or in mixtures thereof. Other alternative solvents could be ethylene glycol monobutyl ether, di(ethylene glycol) monobutyl ether (BDG), and other ethylene- and propylene glycols, such as monoethylene glycol (MEG) and diethylene glycol (DEG). The reaction temperature of the quaternizing reaction is suitably in the range of from 20° to 100° C., preferably at least 40° C., more preferably at least 50° C., and most preferably at least 55° C., and preferably at most 90° C. The heating is preferably stopped when the amount of basic nitrogen is 0.1 mmol/g, as measured by titration with 0.1 M perchloric acid in glacial acetic acid.

In a second preferred embodiment, the PEPQ is obtained by reacting the aforementioned alkoxylated fatty amine, or a quaternized derivative of said amine, with the aforementioned multicarboxylic acid or a derivative thereof and a fatty acid or a mixture of fatty acids.

In one embodiment, the PEPQ of this type is one of the compounds described in WO 2012/028542 and WO 2012/089649, the entire contents of which are hereby incorporated herein by reference.

In one embodiment, the PEPQ of this type is prepared by reacting the alkoxylated fatty amine of formula (I) (or a quaternized analog thereof) with the non-hydrophobic multicarboxylic acid derivative of the formula (IIa) or (IIb) and a fatty acid or mixture of fatty acids of the formula R⁴COOH (III), where R⁴CO is an acyl group having 8 to 24, preferably 12 to 24, more preferably 14 to 24, and most preferably 16-24 carbon atoms that may be saturated or unsaturated, linear or branched, followed, if needed, by partial or total quaternization of the resulting product.

Suitable examples of fatty acids of formula (III) are 2-ethylhexanoic acid, n-octanoic acid, n-decanoic acid, n-dodecanoic acid, n-tetradecanoic acid, n-hexadecanoic acid, palmitoleic acid, n-octadecanoic acid, oleic acid, linoleic acid, linolenic acid, eicosanoic acid, docosanoic acid, tetracosanoic acid, coco fatty acid, rape seed fatty acid, soya fatty acid, tallow fatty acid, tall oil fatty acid, gadoleic acid and erucic acid.

A suitable method for the preparation of the products subject of the present disclosure comprises the steps of mixing a compound of formula (III) as defined above with a compound of formula (IIa) or (IIb) as defined above and a compound of formula (I) as defined above, effecting an esterification condensation reaction between the compounds in the mixture, and if a quaternary product is desired, adding an alkylating agent to the condensation reaction product and effecting a quaternization reaction of the condensation product.

The esterification condensation reactions taking place between the compounds (I), (IIa) or (IIb), and (III) are well-known per se in the art. The reactions are preferably being performed in the presence of an esterification catalyst, such as a Bronstedt or Lewis acid, for example methanesulfonic acid, p-toluenesulfonic acid, citric acid or BF₃. When a multicarboxylic acid derivative of formula (IIa) is used, wherein D is O—R₃, the reaction is a transesterification, which alternatively could be performed in the presence of an alkaline catalyst. Also the carboxylic acid (III) may be added as e.g. its methyl ester. Alternatively, other conventional techniques known by the person skilled in the art could be used starting from other derivatives of the multicarboxylic acids, such as from their anhydrides or their acid chlorides.

As would also be clear to a person skilled in the art, alternatively the different esterification reactions could be performed in more than one step, e.g. by first condensing the multicarboxylic acid derivative (IIa) or (IIb) with the alkoxylated fatty amine (I), and then adding the carboxylic acid (III) in a next step. The reactions could take place with or without solvents added. If solvents are present during the reaction, the solvents should be inert to esterification, e.g. toluene or xylene.

The esterification condensation reaction between the components (I), (IIa) or (IIb), and (III) is suitably effected by heating the mixture at a temperature suitably between 120 and 220° C. for a period of from 2 to 20 hours, optionally at a reduced pressure of from 5 to 200 mbar.

For the quaternization step, the alkylating agent is suitably selected from the group consisting of methyl chloride, methyl bromide, dimethyl sulphate, diethyl sulphate, dimethyl carbonate and benzyl chloride, the most preferred alkylating agents being methyl chloride, dimethyl sulphate, dimethyl carbonate or benzyl chloride. As stated above, the quaternization could suitably be performed on the condensation product between the fatty acid, alkoxylated fatty amine and multiacid. Principally, following an alternative synthesis route, the quaternization of the alkoxylated fatty amine (I) could be performed as a first step, which would then be followed by an esterification reaction between (III), (IIa) or (IIb) and quaternized. Either a part of, or all of, the nitrogen atoms may be quaternized. As a further alternative, if a quaternized derivative is desired, a reaction product between the tertiary alkoxylated fatty amine (I) and a multicarboxylic acid derivative (IIa) or (IIb) may be reacted with an alkylating agent, e.g. methyl chloride or dimethyl sulphate, to yield a product that is partly or totally quaternized, before reaction with the carboxylic acid (III). Also, the two processes can be combined such that first a partially quaternized compound is esterified and the resulting polyester is further quaternized.

Quaternization reactions are normally performed in water or a solvent, such as isopropanol (IPA) or ethanol, or in mixtures thereof. Other alternative solvents could be ethylene glycol monobutyl ether, di(ethylene glycol) monobutyl ether (BDG), and other ethylene- and propylene glycols, such as monoethylene glycol (MEG) and diethylene glycol (DEG). The reaction temperature of the quaternizing reaction is suitably in the range of from 20 to 100° C., preferably at least 40, more preferably at least 50 and most preferably at least 55° C., and preferably at most 90° C. The heating is preferably stopped when the amount of basic nitrogen is 0.1 mmol/g, as measured by titration with 0.1 M perchloric acid in glacial acetic acid.

Products of the disclosure where all nitrogen atoms of the product are quaternary are preferred.

The molar ratio between the fatty acid, or mixture of acids, having the formula R⁴COOH (III) and the alkoxylated fatty amine (I) in the reaction mixture is suitably 1:1.2 to 1:10, more preferably 1:1.5 to 1:5, still more preferably 1:2 to 1:4 and most preferably 1:2 to 1:3, and the ratio between the fatty acid (III) and the multicarboxylic acid or derivative (IIa) or (IIb) is suitably 2:1 to 1:8, 1:1 to 1:8, more preferably 1:1.2 to 1:6, still more preferably 1:1.5 to 1:5, still more preferably 1:1.5 to 1:4, still more preferably 1:1.5 to 1:3, and most preferably 1:1.5 to 1:2.5.

An example of a compound of this type has the formula:

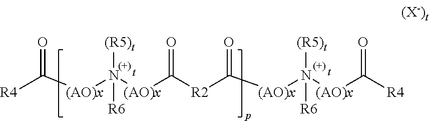

where R4 is C₆₋₂₃ aliphatic, saturated or unsaturated, branched or linear; AO is an alkyleneoxy group having 2-4 carbon atoms, the oxygen atom of which is bonded to the adjacent carbonyl group; each x is independently 2-20; R2 is an alkylene radical of formula —(CH₂)₂—, wherein z is an integer from 0 to 10, preferably from 0 to 6, more preferably from 2 to 4, and wherein the alkylene radical is optionally substituted by 1 or 2 substituents independently selected from —OH, —COOH, and —COOR3; R3 is a C₁₋₄-alkyl group; R5 is a hydrocarbyl group, preferably a C₁-C₄ alkyl group or the benzyl group, R6 is a hydrocarbyl group having 8 to 24 carbon atoms, preferably 12 to 24 carbon atoms or a partial or wholly quaternized derivative thereof; and X⁻ is an anion derived from the alkylating agent; t is a number 0 or 1, preferably 1, and p is typically a number within the range 1-15, and is on average at least 1, preferably at least 2 and most preferably at least 3. The average value of p will depend on the molar ratios of the compounds (I), (IIa) or (IIb) and (III) in the reaction mixture, as well as on the reaction conditions. Suitable anions for this and other embodiments disclosed throughout this specification wherein anions are mentioned include halogenides (preferably chlorides), alkylsulphates (preferably methylsulphate), and alkylcarbonates (preferably methylcarbonate).

In a third preferred embodiment, the PEPQ is obtained by reacting a mixture comprising at least one alkanolamine, at least one monocarboxylic acid, at least one multicarboxylic acid and at least one polyol having 3-4 hydroxyl groups, to form a polyester, and quaternizing the resulting polyester by a suitable alkylating agent.

In one embodiment, the PEPQ of this type is one of the compounds described in U.S. Pat. No. 10,100,146, the entire contents of which are hereby incorporated herein by reference.

In one embodiment, the product is obtainable by the condensation of at least one polyol having 3-4 hydroxyl groups or the alkoxylated product thereof having the formula

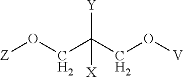

where Z=—(CH₂CH(CH₃)O)ₘ₁(CH₂CH₂O)o(CH₂CH(CH₃)O)ₘ₂T, where T is H, m1 and m2 is independently a number 0-4, preferably m1 and/or m2 is 0, and o is 0 or a number from 1, preferably from 2, to 10, preferably to 5; preferably the sum of all o is 0; Y=—CH₂OZ, —CH₂CH₃ or —OZ; X=H or CH₂OZ; and V=Z or

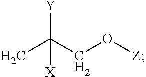

at least one multicarboxylic acid or a derivative thereof having the formula (IIa) or (IIb) above;
at least one alkanolamine having the formula (V)

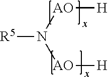

wherein each x independently is a number between 1 and 5, and the sum of all x on average is a number between 2 and 10, AO is an alkyleneoxy group having 2-4 carbon atoms, R⁵ is a C₁-C₄, preferably C₁-C₃ alkyl group, and most preferably a methyl group, or the group [AO]ₓH; and

at least one fatty acid having the formula:

R(C═O)OH (VI)

where R is a hydrocarbyl group having from 7 to 23, preferably 11 to 21, carbon atoms, optionally substituted; followed by reaction with an alkylating agent, suitably a C₁-C₄ alkyl halide, preferably methyl chloride, or dimethyl sulphate.

Neither any alcohol having the general formula R1OH, where R1 is a C₂-C₂₂alkyl or alkenyl group, nor any alkoxylate thereof, is present in the reaction mixture during the condensation reaction.

In one embodiment, the polyol is a compound described above where Y is —O(CH₂CH(CH₃)O)m1(CH₂CH₂O)o(CH₂CH(CH₃)O)m2T, X is H, T is H, and V and Z are both —(CH₂CH(CH₃)O)m1(CH₂CH₂O)o(CH₂CH(CH₃)O)m2T. This polyol is glycerol or alkoxylated glycerol. The values of m1, m2 and o are the same as above, and preferably they are all 0.

For the embodiment above where m1, m2 and o are all 0, and where the alkanolamine of formula (III) is methyl diethanolamine and the quaternization has been performed with methyl chloride, the polymer may for example have the formula:

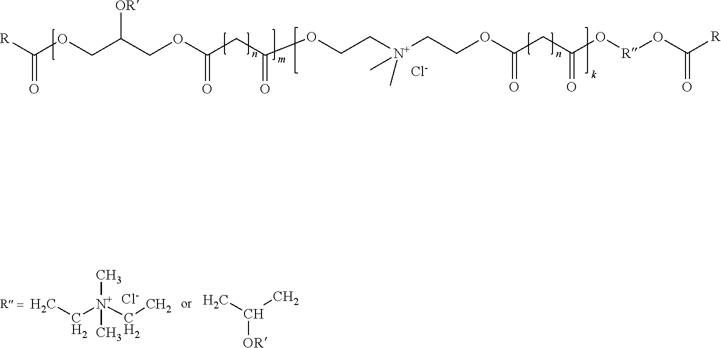

where R is a hydrocarbyl group having from 7 to 23, preferably 11 to 21, carbon atoms, optionally substituted; and R′ is H or R(C═O); and n is an integer 0-10. The average value of k and m will depend on the molar ratios of the appropriate compounds (I), (IIa) or (IIb), (III) and (IV) in the reaction mixture, as well as on the reaction conditions, the m values suitably ranging between 1 and 3, and the k values suitably ranging between 2 and 7. Where m is greater than 1 and thus the molecule contains multiple

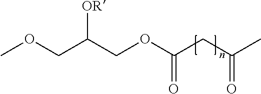

groups, these may the same or different, i.e., the value of R′ and n can be the same throughout all of the groups, or R′ and/or n can independently change from group to group. Likewise, where k is greater than 1 and thus contains multiple

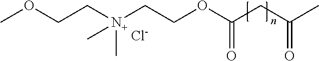

groups, these may be the same or different, i.e., the value of n can be the same throughout all of the groups, or n can independently change from group to group.

The formula above shows one block containing esterified glycerol and diacid, and one block containing esterified alkanolamine and diacid. The “block units” including one glycerol esterified with one diacid may of course be distributed randomly with the “block units” including one alkanolamine esterified with one diacid. The fatty acids either have been esterfied with a primary OH group of a glycerol unit or of an alkanolamine unit, and thus appear at the end of the chains, or have been esterified with a secondary hydroxyl group of one or several of the glycerol units. Thus, there will be hydrophobic groups distributed along the chain as well as at the ends of the chain.

In a fourth preferred embodiment, the PEPQ has the formula:

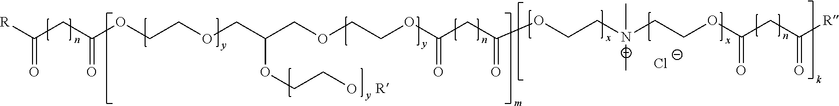

in which
R and R″ are each independently selected from the group consisting of formulae (I)-(V):

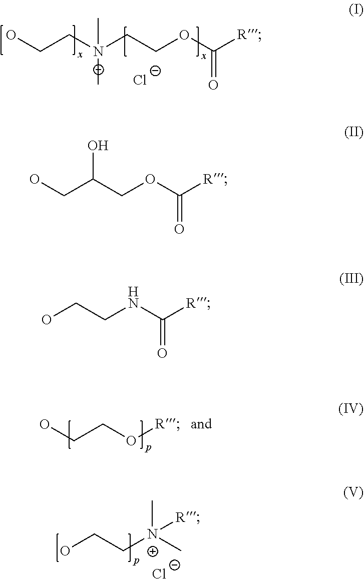

R′ is H or R″C(O);

R′″ is C₆₋₂₃ aliphatic, saturated or unsaturated, branched or linear;

each n is independently 0-10;

m is 0-3;

k is 0-7;

each x is independently 1-10;

each y is independently 0-3; and

p is 2-20.

In the same manner as explained above, where m and/or k are greater than 1, the groups to which they relate can be repeated exactly or differ from group to group, i.e., n, x, and/or y can be kept constant across the various m groups and/or k groups, or they may vary independently across the various m groups and/or k groups.

A suitable method for the preparation of the polyester polyquaternary ammonium compounds subject of the present disclosure comprises the steps of mixing the polyol with a compound of formula (IIa) or (IIb) as defined above, the alkanolamine, and a part of the fatty acid, effecting an esterification condensation reaction between the compounds in the mixture, adding the rest of compound of the fatty acid and esterifying the product in the reaction mixture, adding an alkylating agent to the condensation reaction product and effecting a quaternization reaction of the condensation product.

The esterification condensation reactions taking place between the starting materials are well-known per se in the art. The reactions may be performed with an esterification catalyst, such as a Brönstedt or Lewis acid, for example methanesulfonic acid, p-toluenesulfonic acid, citric acid or BF3, or without any catalyst. When a multicarboxylic acid derivative of formula (IIa) is used, wherein D is O—R3, the reaction is a transesterification, which alternatively could be performed in the presence of an alkaline catalyst. Also other conventional techniques known by the person skilled in the art could be used starting from other derivatives of the multicarboxylic acids, such as from their anhydrides or their acid chlorides.

As would also be clear to a person skilled in the art, alternatively the esterification could be performed in more than one step, e.g. by first condensing the multicarboxylic acid derivative (IIa) or (IIb) with the alkanolamine, and then adding the polyol in a next step, followed by addition of the fatty acid. The reactions could take place with or without solvents added. If solvents are present during the reaction, the solvents should be inert to esterification, e.g. toluene or xylene.

The esterification condensation reaction between the starting materials is suitably effected by heating the mixture at a temperature suitably between 120 and 220° C. for a period of from 2 to 20 hours, optionally at a reduced pressure of from 5 to 200 mbar.

The molar ratio between the polyol and the multicarboxylic acid or derivative (IIa) or (IIb) in the reaction mixture is suitably 1:1.2 to 1:10, more preferably 1:1.5 to 1:5, still more preferably 1:2 to 1:4 and most preferably 1:2 to 1:3, the ratio between the polyol and alkanolamine is suitably 1:1 to 1:8, more preferably 1:1.2 to 1:6, still more preferably 1:1.5 to 1:5, still more preferably 1:1.5 to 1:4, still more preferably 1:1.5 to 1:3 and most preferably 1:1.5 to 1:2.5, and the ratio between the fatty acid and the multicarboxylic acid or derivative (IIa) or (IIb) is preferably 1:1 to 1:5, more preferably 1:1.5 to 1:3 and most preferably 1:1.5 to 1:2.

Suitable polyols having 3-4 hydroxyl groups include pentaerythritol, glycerol, trimethylolpropane, di-trimethylolpropane, erythritol and threitol.

Suitable alkanolamines are N-methyl diethanolamine and N-methyl diisopropanolamine, optionally alkoxylated with ethylene oxide, propylene oxide, butylene oxide or mixtures thereof. If more than one alkylene oxide is reacted with the alkanolamine, the different alkylene oxides may be added in blocks in either order, or may be added randomly.

In a typical reaction the following amounts of the different compounds are used. Per 3 moles of alkanolamine, suitably 2-3.5 moles of fatty acid, 1-2 moles of polyol and 3-4 moles of multicarboxylic acid or a derivative thereof having formula (IIa) or (IIb) are added.

Since there are as many as at least 4 different kinds of monomeric units originating from compounds I, II, III and IV, any attempt to describe the product of the disclosure with a written molecular formula must of necessity only result in some kind of mean molecule, based on the amounts of the starting materials. The actual product will include a large number of different molecules. Even the molecules with the same kinds of units could have the units connected in different order, and contain different amounts of them. Thus the formulae above should only be regarded as examples of how the units may be connected, and the product is better described by the process to make it, as described in the manufacturing process above.

Surprisingly, we have discovered that PEPQs are very efficient hydrotropes and also aid in the cleaning performance of cleaning formulations. In particular, PEPQs exhibit excellent water film-breaking properties and a hydrophobicizing effect that promotes faster drying. As a result, PEPQs are ideally suited for use as rinse aids for automatic dishwashers and carwashes. Indeed, PEPQs enhance the sheeting action in wash rinse aid formulations. When a surface, for example, a dish or a car, is soaked with water, a water sheet forms across the surface. When the rinse aid is then sprayed onto the water soaked surface, draining of the water sheet from the surface is hastened. The final effect is a quicker drying of the surface. A corollary of this is that the rinse aid reduces spotting of and film-forming on the article being cleaned.

In addition, PEPQs exhibit a sticky behavior that leads to increased retention time of the cleaning formulations on the surfaces to be cleaned, even on vertical surfaces. Further, this sticky behavior does not impair the ability of the cleaning formulation to be sprayed. Accordingly, PEPQs are also ideally suited for use in spray-on cleansers, for example, bathroom cleansers intended to be sprayed on vertical hard surfaces, for instance, bathroom tiles and glass.

Moreover, PEPQs exhibit a corrosion inhibition effect, and better biodegradability and ecotoxicity profiles than many existing cleaning formulations.

We have also found that surfaces cleaned with aqueous solutions containing PEPQs exhibit enhanced gloss and softness (surface finishing effect).

In view of the foregoing, it should be readily apparent to persons skilled in the art that the disclosure extends to: the use of PEPQs as a vehicle rinse aid both in automated washes and in manual washes; the use of PEPQs in automatic dishwashing; the use of PEPQs as a drying aid for aqueous solutions to provide faster drying; the use of PEPQs as hydrotropes in hard surface cleaners and other household item cleaning formulations; the use of PEPQs as additives for cleaning formulations to increase the contact time of cleaning formulations on vertical surfaces; and the use of PEPQs for cleaning to impart an enhanced gloss and softness (surface finishing effect).

Cleaning applications in the context of the present disclosure may include, but are not limited to, detergents, fabric cleaners, automatic dishwashing detergents, rinse aids, glass cleaners, fabric care formulations, fabric softeners, flocculants, coagulants, emulsion breakers, alkaline and acidic hard surface cleaners, laundry detergents and others.

The PEPQs according to the present disclosure can be used in a variety of cleaning formulations. Such formulations include liquid laundry formulations such as compact and heavy duty detergents (e.g., builders, surfactants, enzymes, etc.), automatic dishwashing detergent formulations (e.g., builders, surfactants, enzymes, etc.), light-duty liquid dishwashing formulations, rinse aid formulations (e.g., acid, nonionic low foaming surfactants, carrier, etc.) and/or hard surface cleaning formulations (erg., zwitterionic surfactants, germicide, etc.).

Any suitable adjunct ingredient in any suitable amount can be used in the cleaning formulations described herein. Useful adjunct ingredients include, for example, aesthetic agents, anti-filming agents, anti-redeposition agents, anti-spotting agents, anti-graying agents, beads, binders, bleach activators, bleach catalysts, bleach stabilizing systems, bleaching agents, brighteners, buffering agents, builders, carriers, chelants, clay, color speckles, control release agents, corrosion inhibitors, dish care agents, disinfectant, dispersant agents, draining promoting agents, drying agents, dyes, dye transfer inhibiting agents, enzymes, enzyme stabilizing systems, fillers, free radical inhibitors, fungicides, germicides, hydrotropes, opacifiers, perfumes, pH adjusting agents, pigments, processing aids, silicates, soil release agents, suds suppressors, surfactants, stabilizers, thickeners, zeolite, and mixtures thereof.

The cleaning formulations can further include builders, enzymes, surfactants, bleaching agents, bleach modifying materials, carriers, acids, corrosion inhibitors and aesthetic agents. Suitable builders include, but are not limited to, alkali metals, ammonium and alkanol ammonium salts of polyphosphates, alkali metal silicates, alkaline earth and alkali metal carbonates, nitrilotriacetic acids, polycarboxylates, (such as citric acid, mellitic acid, succinic acid, oxydisuccinic acid, polymaleic acid, benzene 1,3,5-tricarboxylic acid, carboxymethyl oxysuccinic acid, and water-soluble salts thereof), phosphates (e.g., sodium tripolyphosphate), and mixtures thereof. Suitable enzymes include, but are not limited to, proteases, amylases, cellulases, lipases, carbohydrases, bleaching enzymes, cutinases, esterases, and wild-type enzymes. Suitable surfactants include, but are not limited to, nonionic surfactants, anionic surfactants, cationic surfactants, ampholytic surfactants, zwitterionic surfactants, and mixtures thereof. Suitable bleaching agents include, but are not limited to, common inorganic/organic chlorine bleach (e.g., sodium or potassium dichloroisocyanurate dihydrate, sodium hypochlorite, sodium hypochloride), hydrogen-peroxide releasing salt (such as, sodium perborate monohydrate (PB1), sodium perborate tetrahydrate (PB4)), sodium percarbonate, sodium peroxide, and mixtures thereof. Suitable bleach-modifying materials include but are not limited to hydrogen peroxide-source bleach activators (e.g., TAED), bleach catalysts (e.g. transition containing cobalt and manganese). Suitable carriers include, but are not limited to: water, low molecular weight organic solvents (e.g., primary alcohols, secondary alcohols, monohydric alcohols, polyols, and mixtures thereof), and mixtures thereof.

Suitable acids include, but are not limited to, acetic acid, aspartic acid, benzoic acid, boric acid, bromic acid, citric acid, formic acid, gluconic acid, glutamic acid, hydrochloric acid, lactic acid, malic acid, nitric acid, sulfamic acid, sulfuric acid, tartaric acid, and mixtures thereof. Suitable corrosion inhibitors, include, but are not limited to, soluble metal salts, insoluble metal salts, and mixtures thereof. Suitable metal salts include, but are not limited to, aluminum, zinc (e.g., hydrozincite), magnesium, calcium, lanthanum, tin, gallium, strontium, titanium, and mixtures thereof. Suitable aesthetic agents include, but are not limited to, opacifiers, dyes, pigments, color speckles, beads, brighteners, and mixtures thereof.

With the addition of suitable adjuncts, cleaning formulations described herein can be useful as automatic dishwashing detergent compositions (e.g., builders, surfactants, enzymes, etc.), light-duty liquid dishwashing compositions, laundry compositions such as, compact and heavy-duty detergents (e.g., builders, surfactants, enzymes, etc.), rinse aid compositions (e.g., acids, nonionic low-foaming surfactants, carriers, etc.), and/or hard surface cleaning compositions (e.g., zwitterionic surfactants, germicides, etc.).

Suitable adjunct ingredients are disclosed in one or more of the following: U.S. Pat. Nos. 2,798,053; 2,954,347; 2,954,347; 3,308,067; 3,314,891; 3,455,839; 3,629,121; 3,723,322; 3,803,285; 3,929,107, 3,929,678; 3,933,672; 4,133,779, 4,141,841; 4,228,042; 4,239,660; 4,260,529; 4,265,779; 4,374,035; 4,379,080; 4,412,934; 4,483,779; 4,483,780; 4,536,314; 4,539,130; 4,565,647; 4,597,898; 4,606,838; 4,634,551; 4,652,392; 4,671,891; 4,681,592; 4,681,695; 4,681,704; 4,686,063; 4,702,857; 4,968,451; 5,332,528; 5,415,807; 5,435,935; 5,478,503; 5,500,154; 5,565,145; 5,670,475; 5,942,485; 5,952,278; 5,990,065; 6,004,922; 6,008,181; 6,020,303; 6,022,844; 6,069,122; 6,060,299; 6,060,443; 6,093,856; 6,130,194; 6,136,769; 6,143,707; 6,150,322; 6,153,577; 6,194,362; 6,221,825; 6,365,561; 6,372,708; 6,482,994; 6,528,477; 6,573,234; 6,589,926; 6,627,590; 6,645,925; and 6,656,900; International Publication Nos. 00/23548; 00/23549; 00/47708; 01/32816; 01/42408; 91/06637; 92/06162; 93/19038; 93/19146; 94/09099; 95/10591; 95/26393; 98/35002; 98/35003; 98/35004; 98/35005; 98/35006; 99/02663; 99/05082; 99/05084; 99/05241; 99/05242; 99/05243; 99/05244; 99/07656; 99/20726; and 99/27083; European Patent No. 130756; British Publication No. 1137741 A; Chemtech, pp. 30-33 (March 1993); J. American Chemical Soc., 115, 10083-10090 (1993); and Kirk Othmer Encyclopedia of Chemical Technology, 3rd Ed., Vol. 7, pp. 430-447 (John Wiley & Sons, Inc., 1979).

In one embodiment, cleaning formulations according to the present disclosure can include a suitable adjunct ingredient in an amount of from 0% to about 99.99% by weight of the formulation. In another aspect, the cleaning formulations can include from about 0.01% to about 95% by weight of the formulation of a suitable adjunct ingredient. In other various aspects, the cleaning formulations can include from about 0.01% to about 90%, or from about 0.01% to about 80%, or from about 0.01% to about 70%, or from about 0.01% to about 60%, or from about 0.01% to about 50%, or from about 0.01% to about 40%, or from about 0.01% to about 30%, or from about 0.01% to about 20%, or from about 0.01% to about 10%, or from about 0.01% to about 5%, or from about 0.01% to about 4%, or from about 0.01% to about 3%, or from about 0.01% to about 2%, or from about 0.01% to about 1%, or from about 0.01% to about 0.5%, or alternatively from about 0.01% to about 0.1% by weight of the formulation of a suitable adjunct ingredient.

The pH of these formulations can range from 1 to 14 when the formulation is diluted to a 1% solution. Most formulations are neutral or basic, meaning in the pH range of 7 to about 13.5. However, certain formulations can be acidic, meaning a pH range from 1 to about 6.5.

One skilled in the art will recognize that the amount of PEPQs required depends upon the cleaning formulation and the benefit the PEPQs provide to the formulation. The PEPQs of the present disclosure can be provided to cleaning formulation manufacturers, for example, dishwashing liquid manufacturers, or to end users, for example, automatic car washing establishments or consumers, as the compounds per se, as ready-to-use formulations, or as concentrates, and the like.

In one embodiment, the PEPQs are provided as the compound per se. In this form, the compound comprises the PEPQ optionally in admixture with a suitable solvent, for example, water or an environmentally friendly organic solvent, such as a simple alcohol (e.g., methanol, ethanol) or an alkane (e.g., heptane, hexane). In one embodiment, the disclosure contemplates a formulation including the PEPQs and water. In another embodiment, the disclosure contemplates a formulation including the PEPQs and methanol, ethanol, heptane, hexane, and combinations thereof, optionally with water.

In one embodiment, the PEPQs are provided in ready-to-use formulations. In such ready-to-use formulations, the PEPQs will be present in a range of about 0.01% to about 20% by weight, preferably about 0.01% to about 10% by weight, most preferably about 0.1% to about 2% by weight, based on a total weight of the formulation. Such ready-to-use formulations typically contain one or more suitable adjunct ingredients in the amounts specified hereinabove and a balance of water.

In another embodiment, the PEPQs are provided in concentrated formulations. Such concentrated formulations when diluted with water have compositions that approximate the ready-to-use formulations with the water being provided typically by the end user. In the concentrates, therefore, the PEPQs can range anywhere from about 0.1% to about 99.9% by weight, preferably about 30% to about 75% by weight, most preferably about 35% to about 70% by weight, based on a total weight of the concentrate. The one or more adjunct ingredients will typically make up the balance of the concentrate in each case, i.e., the one or more adjunct ingredients will be present from about 99.9% to about 0.1% by weight, preferably about 70% to about 25% by weight, most preferably about 65% to about 30% by weight, based on a total weight of the concentrate. It is also possible that the concentrate contains even significant quantities of water.

In one embodiment, the cleaning formulation is a separate liquid rinse aid composition. In one embodiment, the vehicle rinse aid formulations contains: (A) an emulsifier having an HLB around 3-15, for example, selected from the group consisting of: nonionic ethoxylated surfactants; nonionic alkoxylated surfactants; alkyl amine ethoxylates; alkyl amide ethoxylates; alkyl glucosides; and mixtures thereof; (B) oils and/or waxes, for example, selected from the group consisting of: non-polar ester oils; mineral oils; polysiloxane, cyclomethicone, cyclopenthasiloxane; silicones; siloxanes and silicones; and mixtures thereof; and (C) PEPQs as hydrophobizing agent. These components (A), (B), and (C) can be present in the amounts provided above generally for adjunct ingredients (components (A) and (B)) and the PEPQs.

In another embodiment, the PEPQ is a rinse aid additive combined with a detergent, for example, in a liquid detergent formulation, or a unit formulation, such as a pod, which might be designed within the unit to comprise a zone for a detergent composition and a separate zone for the PEPQ rinse aid composition.

In one embodiment, the surface to be cleaned is a kitchen item, preferably selected from cookware, dishware, cups, glasses, and eating utensils.

In another embodiment, the cleaning is carried out in an automatic dishwasher, and the item to be cleaned, a detergent formulation, and the rinse aid composition are introduced to the dishwasher. The use of rinse aid compositions in automatic dishwashers is well-known to persons skilled in the art and details of such use are omitted here. Typically, the rinse aid composition is provided as a liquid formulation separate from the detergent and introduced to the dishwasher via a dedicated liquid rinse aid compartment.

In another embodiment, the cleaning is performed manually, for example, with a liquid detergent composition comprising the PEPQ as a rinse aid.

In another embodiment, the surface to be cleaned is a vehicle, for example, a motorcycle, a car, a truck, a plane, a train, or other form of transportation.

In another embodiment, the cleaning of the vehicle is carried out in an automatic carwash, and the detergent and the rinse aid composition are introduced to machinery of the automatic carwash. The use of rinse aid compositions in automatic carwashes is well-known to persons skilled in the art and details of such use are omitted here. Typically, the rinse aid composition is provided as a liquid formulation separate from the detergent and introduced to water to be used in the rinse stage. This allows dosing of the rinse aid composition by injecting a predetermined amount into a rinse water delivery pipe at an automated car wash for spraying onto wet surfaces of vehicles that were cleaned in previous steps.

In another embodiment, the cleaning of the vehicle is performed manually, for example, with a composition comprising the PEPQ as a rinse aid. Typically, the process involves washing the car using, for example, a specialty carwashing detergent, followed by rinsing off the detergent and then applying the rinse aid formulation, for example, by spraying, as a next step.

In another embodiment, the surface to be cleaned is glass, porcelain, ceramic, or stone.

In another embodiment, the surface to be cleaned is a vertically mounted surface, as for example bathroom, kitchen tile, windows, facades, inner or outer surface of tanks . . . .

In yet another embodiment, the rinse aid composition is sprayed on the surface to be cleaned. In this embodiment, due to the sticky properties that the PEPQs impart to the cleaner formulation as a whole, the cleaner formulation is retained on even vertically mounted surfaces, such as vertically mounted bathroom or kitchen tiles, for extended periods, facilitating and improving the cleaning of such surfaces. The use of such cleaning formulations for such purpose is well-known to persons skilled in the art and details of such use is omitted here. Typically, when applied to vertical surfaces, the cleaning formulation tends to flow downward due to gravity. The PEPQs impart a stickiness to the cleanser, without increasing its viscosity, that inhibits this flow significantly with the results that more of the cleaners remains for a longer period of time at the spray site and the cleaning is facilitated and improved.

When the PEPQ is an additive for cleaning formulations (hydrotropic power and substantivity), the cleaning formulation will also typically contain also: (A) surfactants (nonionic, cationic, amphoteric); (B) chelating agents (e.g., EDTA, GLDA, MGDA); (C) organic solvents (e.g., glycerol, PEG, ethanol, IPA); (D) perfumes and dyes; and (E) combinations thereof. Where the cleaning formulation is intended for bathroom use, as is well-known to persons skilled in the art, pH will typically be adjusted to low values (e.g., pH 3-5) using weak organic acids, as for example citric acid, oxalic acid, lactic acid and mixtures thereof.

### EXAMPLES

The disclosure will now be described in greater detail with reference to the following non-limiting examples.

### Example 1

The polyester of an ethoxylated amine was synthesised as follows:

Succinic anhydride (75.6 g, 0.76 mole) from DFS Fine Chemicals and Ethomeen T/12 [tallowbis(2-hydroxyethyl)amine] (311.3 g, 0.91 mole) from Nouryon Surface Chemistry AB were added to a round-bottomed flask fitted with a condenser, a thermometer, a heating mantle, a nitrogen inlet, and a mechanical stirrer. The reaction mixture was slowly heated to 165±5° C. Water produced during the reaction started to distil off at 151° C. and was removed continuously via ordinary distillation. The reaction was followed by conventional ¹H-NMR spectroscopy (25° C., in CDCl₃, 64 transients, using a Varian® 400 MHz) and acid value titration. After 2 h at 165° C. the acid value of the product had decreased to 0.018 meq/g and the NMR spectrum of the synthesized product showed the reaction to be complete. 272.4 g of the final product were obtained as a brownish liquid. By using SEC/MS, the product was shown to include more than 95 of the SEC area-% of oligomers/polymers with two or more alkoxylated amine units and one diacid/acid anhydride unit or two or more alkoxylated amine units and two diacid/acid anhydride units.

### Example 2

The polyester of an ethoxylated amine was synthesised as follows:

Succinic acid (86.2 g, 0.73 mole) from Acros Organics and Ethomeen T/15 [polyoxyethylene(5) tallow amine] (406.0 g, 0.88 mole) from Nouryon Surface Chemistry AB were added to a round-bottomed flask fitted with a condenser, a thermometer, a heating mantle, a nitrogen inlet, and a mechanical stirrer. The reaction mixture was slowly heated to 165±2° C. Water produced during the reaction was removed continuously via distillation, first for 4 h at atmospheric pressure and then for 9 h at reduced pressure (18 mbar). The reaction was followed by acid value titration. Once the acid value of the product had decreased to 0.113 meq/g the reaction was stopped. 446 g of the final product were obtained as a brownish liquid. By using SEC/MS, the product was shown to include >93 SEC area-% of oligomers/polymers with at least two alkoxylated amine units and one diacid/acid anhydride unit or two alkoxylated amine units and two diacid/acid anhydride units.

### Example 3

A polyester polyquatemary amine was synthesised as follows:

In the first step, succinic anhydride (65.1 g, 0.65 mole) from DSM and Ethomeen T/15 [polyoxyethylene(5) tallow amine] (361.4 g, 0.78 mole) from Nouryon Surface Chemistry AB were added to a round-bottomed flask fitted with a condenser, a thermometer, a heating mantle, a nitrogen inlet, and a mechanical stirrer. The reaction mixture was slowly heated to 165±2° C. Water produced during the reaction was removed continuously via distillation, first for 1 h at atmospheric pressure and then for 3 h at reduced pressure (21 mbar). The reaction was monitored by acid value titration. Once the acid value of the product had decreased to 0.119 meq/g the reaction was stopped. 403 g of the product from the esterification step were obtained as a brownish liquid.

In the second step, the polyester product obtained above (178.7 g) and the solvent butyl diglycol (BDG; 96.6 g) were added to a stirred autoclave and heated to 59° C. Methyl chloride (15.8 g) was added during a period of 4 minutes. The reaction mixture was then further heated at 72±2° C. for 18 h. When the pressure in the reactor had dropped to 0.9 bar and ¹H-NMR spectroscopy showed that no unquaternized amine was left, the heating was stopped. The discharged product was a clear viscous liquid containing 34% w/w of BDG.

### Example 4

The polyester of an ethoxylated amine was synthesised as follows:

Succinic acid (92.9 g, 0.79 mole) from Acros Organics and Ethomeen O/12 [oleylbis(2-hydroxyethyl)amine] (330.1 g, 0.94 mole) from Nouryon Surface Chemistry AB were added to a round-bottomed flask fitted with a condenser, a thermometer, a heating mantle, a nitrogen inlet, and a mechanical stirrer. The reaction mixture was slowly heated to 160±2° C. Water produced during the reaction was removed continuously via distillation, first for 3 h at atmospheric pressure and 160° C., then for 7 h at reduced pressure (24 mbar) and 165° C. The reaction was followed by acid value titration. Once the acid value of the product had decreased to 0.048 meq/g the reaction was stopped. 388 g of the final product were obtained as a brownish liquid. By using SEC/MS, the product was shown to include >97 area-% of oligomers/polymers with at least two alkoxylated amine units and one diacid/acid anhydride unit or two alkoxylated amine units and two diacid/acid anhydride units.

### Example 5

Tallow fatty acid (Tefacid; 230.1 g, 0.82 mole), methyl diethanolamine (195.3 g, 1.64 mole) from Fluka, and adipic acid (179.7 g, 1.23 mole) from Fluka were added to a round-bottomed flask fitted with a condenser, a thermometer, a heating mantle, a nitrogen inlet, and a mechanical stirrer. The reaction mixture was slowly heated to 174° C. Commencing at 150° C., the water produced during the reaction started to distil off. After 3.5 h, vacuum was applied gradually in order to more completely remove the water. In 4 h, the endpoint vacuum of 16 mbar was reached. The progress of the reaction was monitored by titration for acid value as well as by ¹H-NMR spectroscopy. After 7 h at 174° C. and 16 mbar the desired product was obtained. The acid value of the product was then 0.183 meq/g. 541 g of product were obtained. By using SEC/MS, the product was shown to include >86 SEC area-% of molecules with two fatty acid units, two or more alkanolamine units, and one or more diacid/acid anhydride units. Further, the GPC/SEC analysis in combination with fraction analysis using mass spectroscopy reveals that almost all molecule components in the product (>85% w/w) have a molecular weight >700.

### Example 6

A polyester polyquaternary amine was synthesised as follows:

In the first step, oleic acid (479.3 g, 1.69 mole), methyl diethanolamine (498.5 g, 4.18 mole) from Fluka, and adipic acid (458.6 g, 3.14 mole) from Fluka were added to a round-bottomed flask fitted with a condenser, a thermometer, a heating mantle, a nitrogen inlet, and a mechanical stirrer. The reaction mixture was slowly heated to 174° C. Commencing at 156° C., the water produced during the reaction started to distil off. After 3 h, vacuum was applied gradually in order to more completely remove the water. In 3 h, the endpoint vacuum of 37 mbar was reached. The progress of the reaction was monitored by titration for acid value as well as by ¹H-NMR spectroscopy. After 9 h at 174° C. and 37 mbar the desired product was obtained. The acid value of the product was then 0.248 meq/g. 1280 g intermediate product were obtained.

In the second step, 302.6 g of the polyester obtained from the first step and 54 g of water as solvent were added to a stirred autoclave and heated to 59° C. Methylchloride (50 g) was added in one hour. Post-reaction was then carried out for 11 h at 72±2° C.

¹H-NMR spectroscopy showed that no unquaternized amine was left. 378 g of the final product were obtained as a dark brown viscous liquid containing 13% w/w of water.

### Example 7

A polyester polyquatemary amine was synthesised as follows:

The first step is described in Example 5.

In the second step, 240.2 g polyester from the first step and 43.5 g butyl diglycol as solvent were added to a stirred autoclave and heated to 57° C. Methylchloride (36.6 g) was added in 90 minutes. Post-reaction was then carried out for 10 h at 93±3° C. ¹H-NMR spectroscopy showed that no unquaternized amine was left. 252 g of the final product were obtained as a paste containing 13.6% w/w of BDG.

The chain length of the individual molecules and the distribution of the different molecules in the product are not expected to change during step 2 of the synthesis. However, the Mw of each molecule containing one or more methyl diethanol amine fragments is higher after quaternization, and consequently the Mw of the product as a whole will increase slightly as compared to the product of Example 5.

### Example 8

Tallow fatty acid (Tefacid 2005-11091 ex Karlshamn; 120.0 g, 0.43 mole), Ethomeen T/12E (370.0 g, 1.07 mole) from Nouryon and succinic anhydride (85.6 g, 0.86 mole) from DFS Fine Chemicals were added to a round bottomed flask fitted with a condenser, a thermometer, a heating mantle, a nitrogen inlet and a mechanical stirrer. The reaction mixture was slowly heated to 170° C. Commencing at 156° C., the water produced during the reaction started to distil off. Water removal at atmospheric pressure was continued for 1 h at 156-168° C. Thereafter, vacuum was applied gradually in order to more completely remove the water. In 1 h, the endpoint vacuum of 22 mbar was reached. Water removal under vacuum was continued for additionally 6 h. The progress of the reaction was monitored by titration for acid value as well as by ¹H-NMR spectroscopy. After the outlined vacuum distillation the acid value of the product was 0.086 meq/g, and the reaction was stopped. 541 g of product was obtained.

### Example 9

42.5 g (0.15 mol) of tall oil fatty acid, 107.2 g (0.9 mol) of methyldiethanolamine, 55.2 g (0.6 mol) of glycerol and 175.3 g (1.2 mol) of adipic acid were charged to a round bottom flask equipped with a condenser, a heating mantel, a stirrer and a nitrogen inlet. The temperature of the reaction mixture was gradually increased during 1 h to 165° C., then vacuum was applied (99 mBar) and the reaction water was distilled off. Then pressure in the flask was gradually decreased till 50 mbar, and the reaction was continued at 166° C. and 50 mbar for approximately 4 h. After that an additional 194.8 g (0.69 mol) of tall oil fatty acid was added, and the reaction was continued at 166° C. and 46-50 mbar for 6 h more. At that time the acid value of the product was 0.35 meq/g. 516.4 g of polyester polyamine were collected.

225 g of polyester polyamine and 106 g of isopropanol were added to the autoclave and the reaction mixture was heated up to 60° C. Then 19.6 g of methyl chloride was added to the reaction mixture. The postreaction was carried out at 75° C. for 17 h. The total amount of basic nitrogen in the final product was 0.060 meq/g.

The final product was analysed by 1H-NMR spectroscopy.

¹H-NMR (CD3OD): δ 0.95 (—(CH2)n-CH3); δ 1.3 (˜CH2-CH═CH—CH2-CH═CH—CH2-(CH2)n-CH3); δ 1.6 (—O—C(O)—CH2-CH2-CH2); δ 2.1 (˜CH2-CH═CH—CH2-CH═CH—CH2-(CH2)n-CH3); δ 2.3-2.5 (—O—C(O)—CH2-CH2-); δ 2.8 (—CH2-CH═CH—CH2-CH═CH—CH2-(CH2)n-CH3); δ 3.3 (—CH2-N+(CH3)2-CH2-); δ 3.85 (—CH2-N+(CH3)2-CH2-; δ 4.1-4.3 (—C(O)—O—CH2-CH(OC(O))—CH2-O—C(O)—); 4.6 (—C(O)O—CH2-CH2-N+(CH3)2-; δ 5.3 (—C(O)—O—CH2-CH(OC(O))—CH2-O—C(O)—); δ 5.4 (—CH2-CH═CH—CH2-CH═CH—CH2-(CH2)n-CH3). By the use of 1H, 13C and 2D NMR techniques the amounts of the components of the obtained composition of the final product were estimated.

### Example 10

A polyester polyquaternary amine was synthesised as follows:

### Step 1

Distilled oleic acid (Radacid 0213, 187.0 g, 0.66 mole), adipic acid (Fluka, 179.2 g, 1.23 mole) and methyldiethanolamine (Fluka, 194.4 g, 1.63 mole) were added to a round-bottomed flask, fitted with a condenser, a thermometer, a heating mantel, a nitrogen inlet and a mechanical stirrer. The reaction mixture was heated up (set temp at 165° C.) and the produced during the reaction water was distilled off. The distillation started at 156° C. The vacuum was applied in 2 h after distillation started. The process of going down in pressure took 1.5 h (from atm till 8 mBar). The progress of the reaction was evaluated by the determination of acid value and by ¹H-NMR spectroscopy. After 9 h at 165° C. and 8 mBar, the acid value had decreased to 0.155 meq/g and the reaction was stopped. 495 g of intermediate product was collected.

### Step 2

482.7 g of the above intermediate product and 249.7 g of butyl diglycol was added to a stirred autoclave and heated to 58° C. Methylchloride (77.2 g, 1.529 mole) was added in portions for a period of three hours. Post-reaction was then carried out for 12 h at 76±3° C. in order to ensure complete reaction. During this time, the pressure in the autoclave dropped to 0.34 bar and then stayed constant.

Subsequently, an additional 205 g of butyl diglycol was added to the autoclave, the reaction mixture was mixed during 10 min and the final product (containing 45 wt % butyl diglycol) was discharged from the autoclave. The amine value of the product was 0.02 meg/g.

### Example 11

A polyester polyquaternary amine was synthesized as follows:

### Step 1

N-Methyl Diethanol Amine (MDEA; 197.9 g, 1.66 mol) was charged to a 1 1 autoclave.

The system was closed, heated to 60° C. and three N2/vacuum cycles were performed. Then KOH solution (0.58 g KOH in ca 20 ml MeOH) was added at 0.50 bar. Next, temperature was increased to 80° C. (1° C./min ramp) while pulling vacuum to remove the methanol.

The vacuum valve was closed and the temperature was increased to 160° C. Addition of EO (293 g, 6.64 mol) was then initiated and an exothermic reaction was observed. The addition and post reaction were complete within one hour. The reaction product was then cooled to 80° C. and 484 g of the product was collected as a dark brown oil. 0.57 g acetic acid was added to neutralize the KOH.

### Step 2

Adipic acid (89.16 g, 0.61 mol) and oleic acid (Radacid 0213; 89.27 g, 0.328 mol) were added to 228.51 g ethoxylated MDEA from Step 1 at 60° C. in a 700 ml flank flask (equipped with over head stirring (U-bar), thermometer inside reaction connected to heating mantle, distillation set-up and N2/vacuum connection) to give a uniform brown solution. The temperature was slowly increased to 165° C. when distillation started. The reaction was kept at this temperature for 13.5 h and then at 175° C. for 1.5 h. Next, the reaction was cooled to room temperature and 356.4 g of the product was collected as a brown oil. The acid number was 0.356 mmol/g (indicating 89% conversion).

### Step 3

Polyester polyamine from Step 2 and Butyl Diglycol (BDG, 146.2 g) was added to an autoclave. Three N2/vacuum cycles to remove oxygen and a pressure check to 3.6 bar of N2 were performed. Stirring was set at 1500 rpm, the temperature was increased to 80° C. and the system evacuated to 0.05 bar. Addition of CH₃Cl was then initiated and 33.7 g of CH₃C1 was added over 2 h while keeping the pressure below 2.5 bar. The temperature varied between 80-84° C.

A sample was then taken from the reaction and Nₜₒt was measured to 0.239 mmol/g (89% conversion). Another 6.8 g CH₃Cl was then added over 1 hour while keeping the pressure below 2.7 bar and temperature at 77° C. The reaction was left over night at this temperature. The reaction was then stopped and 504.1 g of the liquid brown product was collected.

Acid number was 0.26 mmol/g; Nₜₒt=0.043 mmol/g (97% conversion); Active contents=72% (28% BDG).

### Example 12: Use of PEPQs as Hydrotropes

To evaluate the use of PEPQs as hydrotropes in cleaning formulations the cloud point of regular cleaning formulations were determined. The formulations used contained: 5% ethoxylated alcohol (C₉₋₁₁ 4EO), 3.8% GLDA and a variable concentration of PEPQs or SXS (Stepan Co.) (see table below).

To experimentally determine the cloud point of cleaning formulations, the formula is placed in a test tube together with a thermometer. The test tube is then placed in a water bath and heated gently to complete turbidity. The samples are allowed to cool down slowly while stirring with the thermometer until a clear solution is observed. The temperature at which the system clarifies is recorded as the cloud point for the given system.

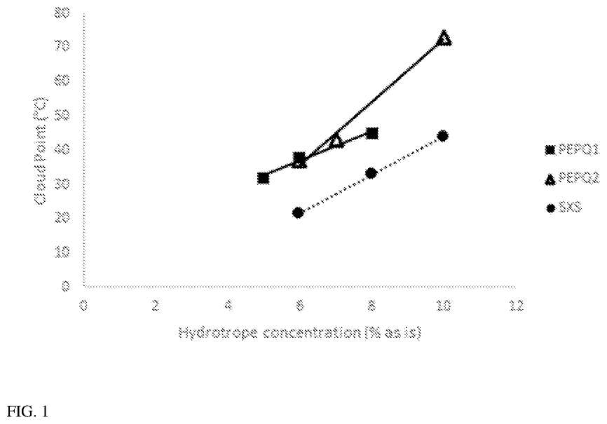

The solubility of nonionic surfactants in water decreases with increasing the temperature. The system evaluated (C9 4EO+GLDA), without hydrotrope, separates at room temperature. A good hydrotrope would increase the solubilization of nonionic surfactants and would move the formulation's cloud point to higher values. FIG. 1 shows that both PEPQs tested increased the cloud point of cleaning formulas as its concentration is raised.

| C9-11 | | | | | |
|---|---|---|---|---|---|
| 4EO | GLDA | PEPQ1 | PEPQ2 | SXS | CP (° C.) |
| 5 | 8 | 5 | | | 32 |
| 5 | 8 | 6 | | | 38 |
| 5 | 8 | 8 | | | 45 |
| 5 | 8 | | 6 | | 37 |
| 5 | 8 | | 7 | | 43 |
| 5 | 8 | | 10 | | 73 |
| 5 | 8 | | | 6 | 21.5 |
| 5 | 8 | | | 8 | 33 |
| 5 | 8 | | | 10 | 44 |

### Example 13: Use of PEPQs in Bathroom Cleaner Sprays

The following experiments were carried out to evaluate the use of PEPQs as “sticky” surfactants to improve stickiness/retention time of sprayed cleaning formulations on vertical ceramic tiles and glass surfaces without impairing sprayability.

Three different commercial bathroom cleaner sprays were purchased and spiked with the same content of the PEPQ of Example 9.

The three products are AJAX optimal 7, Änglamark Badrumsspray and Seventh Generation Bathroom cleaner. Ingredient information on labels are somewhat lacking but is summarized in the table below.

| | |
|---|---|
| Änglamark | <5% nonionic surfactant (fatty alcohol 5EO), |
| | Sodium Lauryl sulfate, Citric acid, Lactic acid, |
| | Ethanol and isopropanol. pH = 2.1 |
| Seventh generation | No information |
| Ajax | “contains ammoniac”, no additional information |

The three detergents were formulated as blank, 0.5%, 1% and 2% formulations of the PEPQ of Example 9 based on total weight and put into identical spray bottles. All four formulations of each cleaner were sprayed side-by-side on each respective surface and evaluated visually. Hazy or opaque samples are not evaluated.

The results achieved were as follows:

| | CONCENTRATION | | |
|---|---|---|---|
| | 0.5% | 1% | 2% |
| Formulation with Example 9 | | | |
| Änglamark | clear | hazy | hazy |
| Seventh Generation | clear | clear | clear |
| Ajax | opaque | clear | clear |
| Stickiness on Ceramic Tiles vs. Blank | | | |
| Änglamark | Better | n/a | n/a |
| Seventh Generation | Better | Better | Much |
| | | | Better |
| Ajax | n/ab | Better | Much |
| | | | Better |
| Stickiness on Glass vs. Blank | | | |
| Änglamark | Better | n/a | n/a |
| Seventh Generation | n/a* | Much | Much |
| | | Better | Better |
| Ajax | n/a | Better | Much |
| | | | Better |
| Stickiness on Stainless Steel vs. Blank | | | |
| Änglamark | Much | n/a | n/a |
| | Better | | |
| Seventh Generation | n/a* | Much | Much |
| | | Better | Better |
| Ajax | n/a | Much | Much |
| | | Better | Better |

*ran out of formulation

The foregoing results show cleaning formulations containing the PEPQs are significantly improved compared to the blank formulations in terms of the retention time of the spray formulations on walls, even at modest concentrations.

### Example 14: Use of PEPQs as Vehicle Rinse Aid

To evaluate the performance of PEPQs as hydrophobizing agent a vehicle finished metallic tile was vertically positioned inside a sink and rinsed with abundant water, until a water film was formed on the surface. Immediately after, a 0.1% PEPQ sample was sprayed on the surface and the break of the water film was observed.

Two di-alkyl quatz were compared to two commercial diacid based PEPQs from Nouryon (Armohib CI-5150 and Armoflote ECO), and a citric acid based experimental PEPQ sample. The following were compared: (1) the water film drainage without any hydrophobizing agent; (2) the water film drainage after a 0.1% solution of the sample was sprayed on the top of the water film; and (3) the water film drainage after a posterior rinse with tap water. The results obtained show that PEPQs tested promoted a significantly faster drainage of the film than the di-alkyl quatz during application and in the secondary rinse process.

While the present disclosure has been described in conjunction with the specific embodiments set forth above, many alternatives, modifications and other variations thereof will be apparent to those of ordinary skill in the art. All such alternatives, modifications and variations are intended to fall within the spirit and scope of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. A method of cleaning a surface of a household item or a vehicle, said method comprising contacting the surface with an aqueous solution comprising a polyester polyquaternary (PEPQ) compound.

2. The method according to claim 1, wherein the surface is the surface of the household item and the household item is chosen from cookware, dishware, cups, glasses, eating utensils, and combinations thereof.

3. The method according to claim 2, further comprising the step of introducing the household item and the polyester polyquaternary (PEPQ) compound into an automatic dishwasher.

4. The method according to claim 1, wherein the surface is the surface of a vehicle.

5. The method according to claim 4, further comprising the step of introducing the polyester polyquaternary (PEPQ) compound in to an automatic carwash.

6. The method according to claim 1, wherein the surface is glass, porcelain, ceramic, metal, wood, stone, or combinations thereof.

7. The method according to claim 6, wherein the surface is vertically mounted.

8. The method according to claim 6, wherein the step of contacting is further defined as spraying.

9. The method according to claim 1, wherein the polyester polyquaternary (PEPQ) compound is obtained by reacting an alkoxylated fatty amine, and/or a quaternized derivative of the amine, with a multicarboxylic acid and/or a derivative thereof.

10. The method according to claim 9, wherein the polyester polyquaternary (PEPQ) compound has the formula: 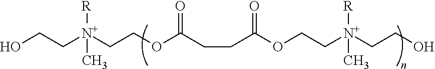
wherein R is a C6-23 aliphatic, saturated or unsaturated, branched or linear group; and n is from 1-10.

11. The method according to claim 1, wherein the polyester polyquaternary (PEPQ) compound is obtained by reacting an alkoxylated fatty amine, and/or a quaternized derivative of said amine, with a multicarboxylic acid and/or a derivative thereof and a fatty acid or a mixture of fatty acids.

12. The method according to claim 11, wherein the polyester polyquaternary (PEPQ) compound has the formula: 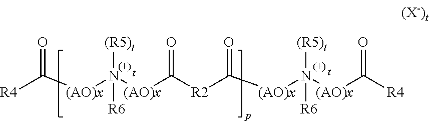
where R4 is a C6-23 aliphatic, saturated or unsaturated, branched or linear group; AO is an alkyleneoxy group having 2-4 carbon atoms, the oxygen atom of which is bonded to the adjacent carbonyl group; each x is independently from 2-20; R2 is an alkylene radical of formula —(CH₂)₂—, wherein z is an integer from 0 to 10, the alkylene radical is optionally substituted by 1 or 2 substituents independently chosen from —OH, —COOH, and —COOR3; R3 is a C1-4-alkyl group; R5 is a hydrocarbyl group or a benzyl group; R6 is a hydrocarbyl group having 8 to 24 carbon atoms or a partial or wholly quaternized derivative thereof; X⁻ is an anion derived from the alkylating agent; t is a number 0 or 1, and p is a number from 1-15.

13. The method according to claim 1, wherein the polyester polyquaternary (PEPQ) compound is obtained by reacting a at least one alkanolamine, at least one monocarboxylic acid, at least one multicarboxylic acid and at least one polyol having 3-4 hydroxyl groups, to form a polyester, and quaternizing the polyester with an alkylating agent.

14. The method according to claim 13, the polyester polyquaternary (PEPQ) compound has the formula: 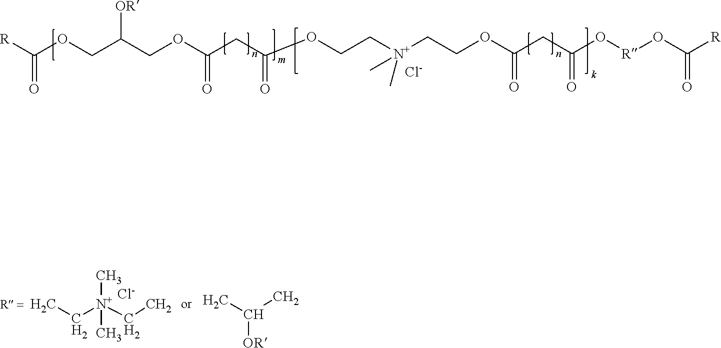
where R is a hydrocarbyl group having from 7 to 23 carbon atoms that is optionally substituted; each R′ is independently H or R(C═O); k is an integer from 2-7; m is an integer from 1-3; and each n is independently an integer from 0-10.

15. The method according to claim 1, wherein the polyester polyquaternary (PEPQ) compound has the formula: 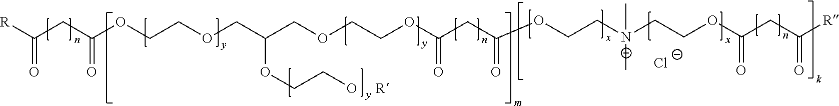
in which
R and R″ each independently have one of the formulae (I)-(V): 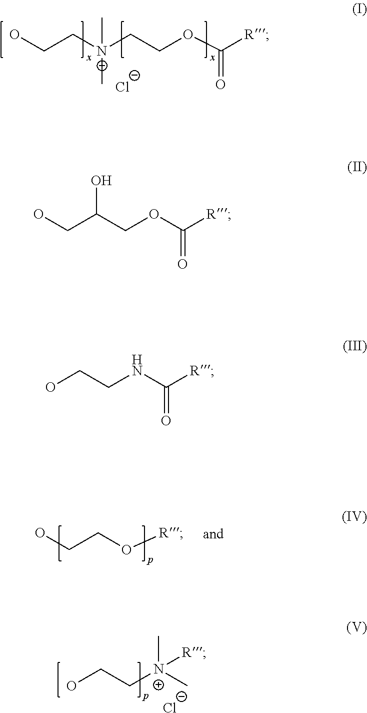
wherein R′ is H or R″C(O);
R′″ is a C6-23 aliphatic, saturated or unsaturated, branched or linear group;
each n is independently from 0-10;
m is from 0-3;
k is from 0-7;
each x is independently from 1-10;
each y is independently from 0-3; and
p is from 2-20.

16. (canceled)

17. A method of cleaning a surface of a household item or a vehicle, said method comprising contacting the surface with an aqueous solution comprising a polyester polyquaternary (PEPQ) compound having the formula: 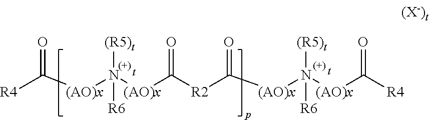
where R4 is a C6-23 aliphatic, saturated or unsaturated, branched or linear group; AO is an alkyleneoxy group having 2-4 carbon atoms, the oxygen atom of which is bonded to the adjacent carbonyl group; each x is independently from 2-20; R2 is an alkylene radical of formula —(CH₂)₂—, wherein z is from 2 to 4, and the alkylene radical is optionally substituted by 1 or 2 substituents independently selected from —OH, —COOH, and —COOR3; R3 is a C1-4-alkyl group; R5 is a C₁-C₄ alkyl group or a benzyl group; R6 is a hydrocarbyl group having 12 to 24 carbon atoms or a partial or wholly quaternized derivative thereof; X⁻ is an anion derived from the alkylating agent;
t is 1, and p is a number from 3-15.

18. A method of cleaning a surface of a household item or a vehicle, said method comprising contacting the surface with an aqueous solution comprising a polyester polyquaternary (PEPQ) compound having the formula: 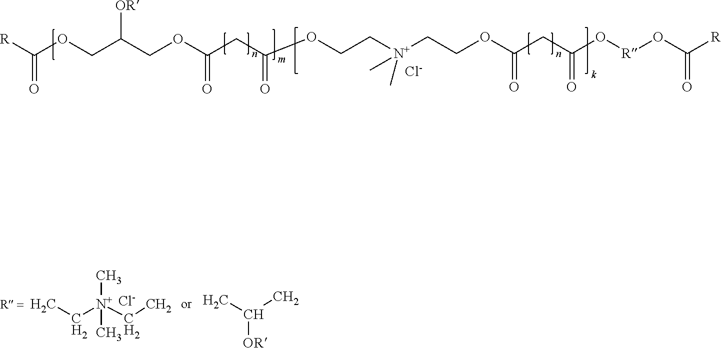
where R is a hydrocarbyl group having from 11 to 21 carbon atoms that is optionally substituted; each R′ is independently H or R(C═O); k is an integer from 2-7; m is an integer from 1-3; and each n is independently an integer from 0-10.
